(19) United States
(12) Patent Application Publication
(10) Pub. No.: US 2024/0367968 A1
(43) Pub. Date: Nov. 7, 2024

(54) USE OF IN-LINE REFRACTIVE INDEX IN CATALYTIC PROCESS

(71) Applicant: VIRENT, INC., Madison, WI (US)

(72) Inventors: Colin Anson, Madison, WI (US); Brian Blank, Madison, WI (US); Rory McAloon, Madison, WI (US); Ryan Wilkinson, Madison, WI (US)

(21) Appl. No.: 18/648,124

(22) Filed: Apr. 26, 2024

Related U.S. Application Data
(60) Provisional application No. 63/499,418, filed on May 1, 2023.

(51) Int. Cl. C01B 3/40

(52) U.S. Cl. CPC C01B 3/40; C01B 2203/107; C01B 2203/1217; C01B 2203/1652

(57) ABSTRACT

The present disclosure provides reactor systems and methods that use in-line measurement of refractive index for monitoring and controlling a catalytic reaction for hydrogen production. An outcome of the catalytic reaction (e.g., total organic carbon level) can be determined using the refractive index data measured in-line from a product stream. Advantageously, the present reactor system can include a control unit for acquiring in-line refractive index data, determining the reaction outcome, and adjusting the catalyst and/or reaction conditions according to the determined outcome, so that progress of the catalytic reaction can be controlled automatically.

### CROSS-REFERENCE TO RELATED APPLICATIONS

This application claims priority to U.S. Provisional patent application No. 63/499,418, filed on May 1, 2023, the content of which is hereby incorporated by reference in its entirety.

### BACKGROUND

As a promising alternative to petroleum-based fuels and chemicals, bioreforming processes provide liquid fuels and chemicals derived from biomass, such as cellulose, hemicellulose, and lignin found in plant cell walls. For instance, cellulose and hemicellulose can be used as feedstock for various bioreforming processes, including aqueous phase reforming (APR) and hydrodeoxygenation (HDO)—catalytic reforming processes that, when integrated with hydrogenation, can convert cellulose and hemicellulose into hydrogen and hydrocarbons, including liquid fuels and other chemical products. In an APR process, hydrogen is produced from water-soluble oxygenate species at temperatures and pressures lower than those used in conventional steam methane reforming (SMR) technology. For example, an APR process may include contacting water and an oxygenated hydrocarbon (such as ethylene glycol, propylene glycol, glycerol, sorbitol, etc.) with a catalyst in either the liquid or vapor phase. Through a series of reactions, H₂ and CO are produced. Under the APR conditions, the water-gas shift (WGS) equilibrium favors H₂/CO₂ production, and CO+H₂O are converted into H₂ and CO₂. Small amounts of gaseous alkanes (CH₄, C₂H₆, C₃H₈, etc.) and water soluble oxygenates (MeOH, EtOH, acetone, iPrOH, etc.) are also produced. APR methods are described, for example, in U.S. Pat. Nos. 6,699,457, 6,964,757, 6,964,758, and 7,618,612 (all to Cortright et al., entitled “Low-Temperature Hydrogen Production from Oxygenated Hydrocarbons”) and U.S. Pat. No. 6,953,873 (to Cortright et al., entitled “Low-Temperature Hydrocarbon Production from Oxygenated Hydrocarbons”), all of which are incorporated herein in their entireties by reference.

### SUMMARY OF THE INVENTION

Described herein are reactor systems and methods that employ in-line measurement of refractive index for monitoring and controlling a catalytic reaction for hydrogen production.

In one aspect, the present disclosure provides a method of controlling a catalytic reaction for hydrogen production. The method can comprise reacting a feed stream comprising water and a water-soluble oxygenated hydrocarbon having at least two carbon atoms, in the presence of a catalyst and under a reaction condition, to produce a product stream comprising a gaseous phase comprising hydrogen and an aqueous phase comprising wastewater. The method can further comprise determining an outcome of the catalytic reaction by measuring in-line the refractive index of the wastewater stream. The method can further comprise adjusting the catalyst, the reaction condition, or both according to the outcome to continue hydrogen production.

In some embodiments, the outcome comprises a total organic carbon (TOC) of the wastewater, a conversion to gas of the feed stream, hydrogen yield of the catalytic reaction, or a combination thereof. The reaction condition can include, for example, temperature, pressure, concentration of the water-soluble oxygenated hydrocarbon, flow rate of the feed stream, or a combination thereof. The water-soluble oxygenated hydrocarbon can comprise glycerol. In some embodiments, the catalyst comprises a metal and a support. The metal can include, for example, Pt, Ru, Re, or a combination thereof. The support can include, for example, activated carbon.

In some embodiments, adjusting the catalyst comprises regenerating the catalyst. In some embodiments, determining the outcome of the catalytic reaction comprises determining a linear correlation between the total organic carbon (TOC) and the refractive index of the wastewater.

In another aspect, the present disclosure provides a system for catalytic reaction to produce hydrogen. The system can comprise a reactor containing a catalyst configured to: (1) receive a feed stream comprising water and a water-soluble oxygenated hydrocarbon having at least two carbon atoms and a catalyst; and (2) discharge a product stream comprising a gaseous phase comprising hydrogen and an aqueous phase comprising wastewater, wherein the feed stream in the reactor undergoes a reaction in the presence of the catalyst and under a reaction condition to produce the product stream. The system can further comprise an in-line refractive index meter configured to measure a refractive index of the wastewater. The system can further comprise an electronic control system configured to adjust the catalyst, the reaction condition, or a combination thereof based on the measured refractive index of the wastewater.

In some embodiments, the electronic control system is configured to: receive refractive index data from the in-line refractive index meter; determine an outcome of the catalytic reaction based on the refractive index data; and adjust the catalyst, the reaction condition, or the combination thereof based on the determined outcome.

### BRIEF DESCRIPTION OF DRAWINGS

FIG. 1 shows a representative system with in-line refractometer meter for an aqueous phase reforming (APR) process.

FIG. 2 shows a linear correlation between refractive index (RI) and product total organic carbon (TOC) in APR wastewater.

FIGS. 3A-3C show in-line RI measurement results from studies conducted in an industrial plant. FIGS. 3A-3B show RI-TOC correlation. FIG. 3C is a Tableau plot showing data resolution down to 30 second increments for on-stream analysis of the RI and automatic conversion of that RI value to a TOC value.

### DETAILED DESCRIPTION OF THE INVENTION

The present disclosure generally relates to the use of in-line measurement of refractive index to monitor the progress of a catalytic reaction for hydrogen production. Advantageously, the present methods and reactor systems can be used to determine an outcome of the catalytic reaction in real time. Based on the results determined by the in-line measurement, the reaction conditions (including catalyst, temperature, pressure, etc.) can be adjusted to improve the yield of hydrogen production.

In some examples, to evaluate the performance of an aqueous phase reforming (APR) process, a sample of the aqueous effluent from the APR process is taken and the total organic carbon (TOC) in the sample is analyzed to determine the carbon content of the aqueous effluent. However, this is a time-consuming analytical method, requires an operator physically be by the plant, and cannot be used to monitor the real time progress of the catalytic reaction. Thus, there is a need for fast, reliable analytical means to monitor the real time performance of the APR process on an industrial scale, so that important settings of the APR reaction can be adjusted to improve yield and overall efficiency.

In one aspect, the present disclosure provides a method of controlling a catalytic reaction for hydrogen production. The method can include reacting a feed stream comprising water and a water-soluble oxygenated hydrocarbon having at least two carbon atoms, in the presence of a catalyst and under a reaction condition, to produce a product stream comprising a gaseous phase comprising hydrogen and an aqueous phase comprising wastewater. An outcome of the catalytic reaction can be determined by measuring in-line a refractive index of the wastewater. The catalyst, the reaction condition, or both, can be adjusted according to the outcome to continue hydrogen production.

The catalytic reaction can be, for example, an aqueous phase reforming (APR) reaction that produces hydrogen from water-soluble oxygenate compounds. The performance of an APR catalytic process can be measured by, for example, H₂ yield and conversion to gas. H₂ yield is a calculation of the amount of H₂ produced relative to the theoretical limit. For example, for glycerol, the theoretical maximum is 7 mols H₂ produced per mol of glycerol (C₃H₈O₃+3 H₂O→3 CO₂+7 H₂). Conversion to gas is a measurement of the amount of carbon that is converted into gaseous products, such as CO, CO₂, CH₄, C₂H₆, C₃H₈, etc. Typically, lower conversion to gas efficiency occurs before significant H₂ yield losses. As such, conversion to gas is an important leading metric for system performance. Typically, the conversion to gas metric is calculated by taking the flow rate of carbon out of the reactor (e.g., g carbon/minute) and dividing it by the flow of carbon into the reactor (e.g. g carbon/minute). In conventional processes, a sample of the aqueous effluent from an APR reaction is taken and the total organic carbon (TOC) in the sample is analyzed to determine the carbon content of the aqueous effluent. However, this is a time-consuming analytical method.

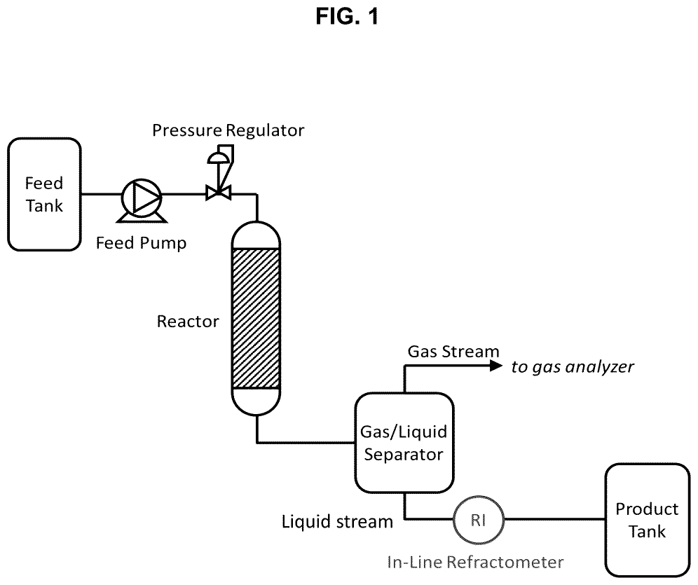

A representative reaction system is illustrated in FIG. 1. The feed stream comprising water and a water-soluble oxygenated hydrocarbon can be transported from a feed source (e.g., a feed tank) to a reactor where the feed stream is introduced to a catalyst. The feed stream is allowed to react in the reactor in the presence of the catalyst under suitable reaction conditions. The catalytic reaction produces a product stream, which can include a gaseous phase comprising hydrogen produced from the reaction and an aqueous phase comprising wastewater. The gaseous phase can comprise other gases (for example, CO, CO₂, and hydrocarbons).

The term “measuring in-line,” “in-line measurement,” or the like refers to measuring a physical property (such as refractive index) of a product by an instrument (such as a refractive index meter) integrated in a production line. The “in-line” measurement as used herein is understood to be distinct from the “off-line,” “near-line,” or “at-line” methods known in the art, which typically involve identifying or removing a sample from the production line and conducting measurement or analysis of the sample by an instrument that is not an integrated part of the production line.

For example, an at-line refractive index (RI) measurement can be accomplished by a handheld refractometer. However, this approach involves taking a sample from the process and an operator to test the sample. An in-line measurement removes the need for taking a sample and allows continuous monitoring of a stream of analyte (e.g., an aqueous effluent stream), which provides a real-time readout of a result of the reaction system (e.g., conversion to gas efficiency).

As shown in the representative system of FIG. 1, the product stream can be separated into a gas stream and a liquid stream (such as an aqueous stream) by a gas/liquid separator. A refractometer can be used to measure the refractive index of the aqueous stream. For example, the refractometer can be installed in-line in the flow path of the aqueous steam after the gas/liquid separator (to avoid plug flow of the gases), thereby in-line RI measurement can be taken before the aqueous stream is collected or removed (e.g., in a product tank). The gas stream can be separately analyzed by a gas analyzer to determine additional results (e.g., yield of hydrogen or hydrocarbons) of the catalytic reaction. The analytical results for the gas stream (e.g., determined by the gas analyzer) and the aqueous stream (e.g., determined by the in-line RI measurement) can be compared or combined for further evaluation of the performance of the reaction.

Thus, the present method can be advantageously employed in unattended/distributed APR systems, where a skilled operator or technician may not be available or onsite. In particular, with an in-line monitor and other analytical tools, the performance of an APR system can be monitored off site.

The in-line measurement of refractive index of the wastewater in the product stream can be used to determine an outcome of the catalytic reaction. Remarkably, as a nonlimiting example, the present disclosure shows a reliable correlation between the refractive index measurement and the total organic carbon (TOC) in the wastewater generated from the catalytic reaction as described herein. The correlation can be, for example, a linear correlation, which can be used to quantitate the total organic carbon in the wastewater. Based on such correlation and quantitation of TOC, other results of the catalytic reaction can be determined directly or in combination with other known analytical means. In some embodiments, the outcome of the catalytic reaction determined by the in-line measurement of refractive index can include a total organic carbon (TOC) of the wastewater, a conversion to gas of the feed stream, hydrogen yield of the catalytic reaction, or a combination thereof. In some embodiments, the outcome is the total organic carbon of the wastewater.

The outcome determined by an in-line measurement of refractive index can provide information to evaluate the progress or performance of the catalytic reaction. Accordingly, one or more of the reaction conditions and/or the catalyst can be adjusted according to the outcome of the catalyst reaction as determined by the present method to continue hydrogen production. As used herein, “adjusting a reaction condition” includes operating a control system (e.g., an automatic control system) to maintain, increase, or reduce a condition for the catalytic reaction. In some embodiments, the reaction conditions subject to adjustment according to the present method include temperature, pressure, concentration of the water-soluble oxygenated hydrocarbon, flow rate of the feed stream, or a combination thereof. The temperature and pressure can refer to the temperature and pressure in a reactor in which the feed stream is allowed to react in the presence of the catalyst.

As used herein, “adjusting a catalyst” includes regenerating a catalyst (e.g., by an oxidative gas such as air), replacing a fouled catalyst with a fresh catalyst (i.e., a less fouled replacement catalyst), or otherwise changing the surface area of a catalyst that is exposed to reagents (e.g., a feed stream) of the catalytic reaction. In some embodiments, adjusting the catalyst comprises regenerating the catalyst. Further, adjustment of the catalyst can be achieved by adjustment of the reactor temperature. For example, the catalyst can be adjusted by increasing the reactor temperature.

### Oxygenated Hydrocarbons and Feed Stream

Suitable oxygenated hydrocarbons include those that are water-soluble and have at least two carbons. In some embodiments, the oxygenated hydrocarbon has from 2 to 12 carbon atoms. In some embodiments, the oxygenated hydrocarbon has from 2 to 6 carbon atoms. In some embodiments, the oxygenated hydrocarbon has a carbon-to-oxygen ratio of 1:1, regardless of the number of carbon atoms in the oxygenated hydrocarbon.

In some embodiments, the oxygenated hydrocarbon is a water-soluble oxygenated hydrocarbon selected from the group consisting of ethanediol, ethanedione, glycerol, glyceraldehyde, aldotetroses, aldopentoses, aldohexoses, ketotetroses, ketopentoses, ketohexoses, alditols, and a combination thereof. In some embodiments, the carbon oxygenated hydrocarbon is a C₃, C₄, C₅, or C₆ hydrocarbon (having 3, 4, 5, or 6 carbon atoms, respectively), or a combination thereof. Suitable C₆ oxygenated hydrocarbons include, for example, aldohexoses and corresponding alditols, such as glucose and sorbitol. Suitable oxygenated hydrocarbons having more than 6 carbon atoms include, for example, sucrose and oligosaccharides. In some embodiments, the oxygenated hydrocarbon includes smaller compounds, such as ethanediol, glycerol, glyceraldehyde, or a combination thereof.

Vapor phase reforming requires that the oxygenated hydrocarbon reactants have a sufficiently high vapor pressure at the reaction temperature so that the reactants are in the vapor phase. In particular, suitable oxygenated hydrocarbon compounds for vapor phase method of the present disclosure include, but are not limited to, ethanediol, glycerol, glyceraldehyde, and a combination thereof. Where the reaction is to take place in the liquid phase, suitable oxygenated hydrocarbons include, for example, glucose, sorbitol, sucrose, and a combination thereof.

In some embodiments, the oxygenated hydrocarbon comprises glycerol. The oxygenated hydrocarbon can include at least 50% glycerol by weight, including but not limited to at least 55%, at least 60%, at least 65%, at least 70%, at least 75%, at least 80%, at least 85%, at least 90%, and at least 95% glycerol by weight.

In the present methods the feed stream can be prepared, for example, by mixing the oxygenated hydrocarbon compound and water to form an aqueous solution. The feed stream can comprise at least 15% by weight a water-soluble oxygenated hydrocarbon, including by not limited to at least 20%, at least 25%, at least 30%, at least 35%, at least 40%, and at least 45% by weight. The feed stream can comprise at most 50% by weight a water-soluble oxygenated hydrocarbon, including by not limited to at most 45%, at most 40%, at most 35%, at most 30%, and at most 25% by weight. In some embodiments, the feed stream comprises about 20% to about 50% by weight the water-soluble oxygenated hydrocarbon, including but not limited to about 20% to about 45%, about 25% to about 40%, and about 25% to about 35% by weight. For example, the feed stream comprises about 20%, about 25%, about 30%, about 35%, about 40%, about 45%, or about 50% by weight the water-soluble oxygenated hydrocarbon. In some embodiments, the water-soluble oxygenated hydrocarbon is glycerol, and the feed stream comprises about 20% to about 50% by weight glycerol, including but not limited to about 25%, about 30%, about 35%, about 40%, and about 45% by weight.

In some embodiments, the feed stream comprising water and the oxygenated hydrocarbon has a pH of from about 4.0 to about 10.0, such as about 4.0 to about 8.0, about 4.0 to about 7.0, about 5.0 to about 8.0, about 5.0 to about 7.0, about 6.0 to about 9.0, or about 6.0 to about 8.0.

The flow rate of the feed stream can be adjusted according to the performance or outcome of the catalytic reaction. The flow rate can be measured as, for example, a weight hourly space velocity (WHSV). In some embodiments, the present method comprises reacting the feed stream at a weight hourly space velocity (WHSV) of about 0.1 hr⁻¹ to about 10 hr⁻¹. The velocity can be, for example, a measurement of the amount of feed stream introduced into the reactor, where the feed stream contact with the catalyst, per unit time. The velocity can be expressed as, for example, weight of oxygenated hydrocarbon (gram) per weight of catalyst (gram⁻¹) per time (hour⁻¹), or in short hr⁻¹. In some embodiments, the feed stream has a weight hourly space velocity of about 0.5 hr⁻¹ to about 10 hr⁻¹, about 1 hr⁻¹ to about 10 hr⁻¹, about 1 hr⁻¹ to about 8 hr⁻¹, about 1 hr⁻¹ to about 5 hr⁻¹, about 1 hr⁻¹ to about 4.5 hr⁻¹, about 1 hr⁻¹ to about 4 hr⁻¹, about 1 hr⁻¹ to about 3.5 hr⁻¹, about 1 hr⁻¹ to about 3 hr⁻¹, about 1 hr⁻¹ to about 2.5 hr⁻¹, or about 1 hr⁻¹ to about 2 hr⁻¹. In some embodiments, the weight hourly space velocity is about 1 hr⁻¹ to about 3.5 hr⁻¹ or about 1 hr⁻¹ to about 2.5 hr⁻¹. In some embodiments, the weight hourly space velocity is about 1.5 hr⁻¹, about 2 hr⁻¹, about 2.5 hr⁻¹, about 3 hr⁻¹, or about 3.5 hr⁻¹.

### Catalysts

The present catalyst can comprise, for example, a metal and a support material. The catalysts as described herein can include known catalyst systems utilized in APR reactions. Suitable catalysts include those metallic catalysts capable of cleaving the C—C bonds of a given oxygenated hydrocarbon compound faster than the C—O bonds of that compound under the chosen reaction conditions. Suitably, the metallic catalyst can have minimal activity toward the cleavage of C—O bonds. Use of a catalyst system having high activity for C—O bond cleavage can result in the formation of undesired by-products, such as alkanes.

Suitably, the metal can adhere to the support material. The metal of the present catalyst can comprise one or more transitional metals, such as nickel (Ni), palladium (Pd), platinum (Pt), ruthenium (Ru), rhodium (Rh), iridium (Ir), an alloy thereof, and a combination thereof. The transition metal may be alloyed or admixed with an additional metal selected from the group consisting of Group IB metals, Group IIB metals, and Group VII metals. The additional metal can be, for example, copper (Cu), zinc (Zn), rhenium (Re), cobalt (Co), manganese (Mn), an alloy thereof, or a combination thereof. In some embodiments, the amount of the additional metal is less than 60 of the weight of the one or more transition metals in the present catalyst, including less than 50%, less than 30%, less than 20%, less than 10%, less than 5%, or less than 1%.

In some embodiments, the metal of the present catalyst comprises platinum and rhenium. For example, the metals Pt and Re can be in a mass ratio of 1:0.5 (also referred to as Pt:Re_{0.5}).

The support can provide a stable platform for the chosen catalyst and the reaction conditions. Suitable supports include, but are not limited to, silica, alumina, zirconia, titania, ceria, carbon, silica-alumina, silica nitride, and boron nitride. Furthermore, nanoporous supports such as zeolites, carbon nanotubes, or carbon fullerene may be utilized. The support can be a powder or an extruded solid. In some embodiments, the support comprises activated carbon, such as activated carbon in powder or granular forms. Suitable support includes commercial products, such as Calgon 208C granular activated carbon (Calgon Carbon Corp., PA).

In some embodiments, the metal is present in an amount of about 0.25% to about 50% by total weight of the catalyst system (the weight of the support being included), such as from about 0.5% to about 30%, from about 1% to about 30%, from about 1% to about 20%, from about 1% to about 10%, or from about 1% to about 5% by total weight. In some embodiments, the metal is present in an amount of about 1%, about 5%, or about 10% by total weight of the catalyst system. In some embodiments, the metal is present in an amount of about 5% by total weight of the catalyst system.

The support may also be treated, as by surface-modification, to remove surface moieties such hydrogen and hydroxyl. Surface hydrogen and hydroxyl groups can cause local pH variations that adversely affect catalytic efficiency. The support can be modified, for example, by treating it with a modifier selected from the group consisting of silanes, alkali compounds, and alkali earth compounds.

Useful catalyst systems for the present method include, but are not limited to: ruthenium supported on silica, palladium supported on silica, iridium supported on silica, platinum supported on silica, rhodium supported on silica, cobalt supported on silica, nickel supported on silica, iron supported on silica, nickel-palladium supported on silica, nickel-platinum supported on silica, ruthenium-palladium supported on silica, and platinum supported on carbon. The metals of these catalysts may be further alloyed or admixed with copper, zinc, and/or rhenium. In some embodiments, the catalysts comprise platinum supported on carbon (Pt/C) or platinum-rhenium supported on carbon (Pt—Re/C).

The catalyst system useful in the reforming reaction of a specific oxygenated hydrocarbon compound may vary and can be chosen based on factors such as overall yield of hydrogen, length of activity, and expense. The catalyst systems as described herein can be prepared by conventional methods, including for example, evaporative impregnation techniques, incipient wetting techniques, chemical vapor deposition, magnetron sputtering techniques, and the like. The method chosen to fabricate the catalyst is not particularly critical to the function of the catalyst. Different catalysts may yield different results, depending upon considerations such as overall surface area, porosity, etc.

### Temperature and Pressure

The present method can be carried out at a temperature at which the thermodynamics of the hydrogen production reaction are favorable. In some embodiments, the temperature of the present method is about 250° C. to about 340° C., including but not limited to about 255° C. to about 340° C., about 260° C. to about 340° C., about 265° C. to about 340° C., about 270° C. to about 340° C., about 275° C. to about 340° C., about 275° C. to about 330° C., or about 275° C. to about 320° C. In some embodiments, the temperature is about 260° C. to about 340° C. or about 275° C. to about 340° C. For example, the temperature can be about 265° C., about 275° C., about 280° C., about 285° C., about 290° C., about 295° C., about 300° C., about 305° C., about 310° C., about 315° C., about 320° C., or about 325° C. In some embodiments, the temperature is about 305° C.

The pressure selected for the reactions may vary with the temperature. For condensed phase liquid reactions, the pressure within the reactor is sufficient to maintain the reactants in the condensed liquid phase. The present method can achieve high hydrogen yield (e.g., at least 40%) at a significantly reduced pressure compared to conventional technology. In some embodiments, the pressure of the present method is about 250 psig to about 650 psig, including but not limited to about 250 psig to about 600 psig, about 250 psig to about 500 psig, about 250 psig to about 400 psig, about 275 psig to about 650 psig, about 275 psig to about 600 psig, about 275 psig to about 500 psig, or about 275 psig to about 400 psig. In some embodiments, the pressure of the present method is about 275 psig to about 650 psig or about 275 psig to about 400 psig. For example, the pressure can be about 280 psig, about 290 psig, about 300 psig, about 310 psig, about 320 psig, about 330 psig, about 340 psig, about 350 psig, about 360 psig, about 370 psig, about 380 psig, about 390 psig, or about 400 psig. In some embodiments, the pressure is about 310 psig.

In some embodiments, the feed stream comprises about 30% by weight glycerol, the catalyst comprises Pt and activated carbon, the temperature is about 305° C., the pressure is about 310 psig, and the weight hourly space velocity is about 1.5 hr⁻¹.

### In-Line RI Measurement

The refractive index (RI) can be measured using known technologies. In some embodiments, the refractive index is measured by a refractometer. In some embodiments, the present method further comprises separating the aqueous phase comprising the wastewater from the product stream prior to measuring in-line a refractive index of the wastewater. As a non-limiting example, the product stream can be separated into a gas stream and a liquid stream (such as an aqueous stream) by a gas/liquid separator and a refractometer can be used to measure the refractive index of the aqueous stream which includes the wastewater (FIG. 1).

Advantageously, the refractive index measured in the present method can have a quantifiable correlation (e.g., a linear correlation) with an outcome of the catalytic reaction as described herein (e.g., the total organic carbon content in the wastewater). In some embodiments, determining the outcome of the catalytic reaction comprises determining a linear correlation between the total organic carbon (TOC) and the refractive index of the wastewater. As an example, the linear correlation can be expressed by a standard curve, which is obtained using signals (e.g., RI values) acquired from known concentrations of an analyte (e.g., TOC).

The data from the in-line refractive index measurement can be processed by an electronic control unit to determine the outcome the of catalytic reaction. For example, the control unit can determine the total organic carbon level based on a pre-determined linear correlation between the total organic carbon level and the refractive index of the wastewater (e.g., a standard curve). Additionally, based on the determined outcome of the catalytic reaction (e.g., TOC level from the effluent of an APR reaction), the control unit can also monitor the progress of the reaction in real time, adjust the catalyst, and/or adjust one or more of the reaction conditions to improve the performance of the reaction. In some embodiments, the outcome of the catalytic reaction as described herein is determined by an electronic control unit. In some embodiments, adjusting the catalyst, the reaction condition, or both is carried out by the control unit. In some embodiments, the control unit determines the outcome of the catalytic reaction based on the results of the in-line refractive index measurement and adjusts the catalyst, the reaction condition, or both in the present method.

The initiation and frequency of the in-line RI measurement as described herein can also be controlled by the control unit. As non-limiting examples, the control unit can send instructions to the refractometer to measure the RI at scheduled time points and, based on the acquired RI value, determine the outcome of the catalytic reaction at those time points. In addition, the control unit may initiate catalyst regeneration or coordinate adjustments of the reaction conditions (e.g., temperature, pressure, or feed stream flow rate) to improve the outcome of the catalytic reaction.

The electronic control unit can be an automated control unit. For example, the control unit may include a computer equipped with programmable software to perform or control one or more operations in the hydrogen production process, such as RI data acquisition, catalyst regeneration, temperature/pressure adjustment, and reaction termination. In particular examples, such a control unit can control or perform these or other operations with partial or no operator intervention (e.g., based on predetermined or adaptive control logic and run-time sensor data).

In another aspect, the present disclosure provides a system for catalytic reaction to produce hydrogen. The system can include a reactor configured to: (1) receive a feed stream comprising water and a water-soluble oxygenated hydrocarbon having at least two carbon atoms and a catalyst; and (2) discharge a product stream comprising a gaseous phase comprising hydrogen and an aqueous phase comprising wastewater, wherein the feed stream in the reactor undergoes a reaction in the presence of the catalyst and under a reaction condition to produce the product stream. An in-line refractive index meter can be configured in the present system to measure a refractive index of the wastewater. An electronic control system can be configured in the present system to adjust the catalyst, the reaction condition, or a combination thereof based on the measured refractive index of the wastewater.

The refractive index meter can be a known device suitable for measuring refractive index. In some embodiments, the refractive index meter is an in-line refractometer as described herein.

In some embodiments, the present system further comprises a separator unit to separate the aqueous phase comprising the wastewater from the product stream. As a non-limiting example, the product stream can be separated into a gas stream and an aqueous stream by the separator unit and a refractometer can be used to measure the refractive index of the aqueous stream which includes the wastewater (FIG. 1).

The present system can be used for reacting a feed stream in the presence of a catalyst as described herein (e.g., suitable feed and catalyst systems for an APR reaction). In some embodiments, the water-soluble oxygenated hydrocarbon comprises glycerol. In some embodiments, the catalyst comprises a metal and a support as described herein.

The electronic control system can be used to control the acquisition and processing of the refractive index data from the in-line refractive index meter. Based on the refractive index data, an outcome of the catalytic reaction (e.g., TOC level) can be determined as described herein (e.g., based on a linear correlation between the refractive index and the outcome). In some embodiments, the electronic control system is configured to receive refractive index data from the in-line refractive index meter; determine an outcome of the catalytic reaction based on the refractive index data; and adjust the catalyst, the reaction condition, or the combination thereof based on the determined outcome. For example, the control system may include a computer equipped with programmable software to perform or control one or more operations in the hydrogen production process, such as RI data acquisition, catalyst regeneration, temperature/pressure adjustment, and reaction termination. In some embodiments, the control system is configured to carried out a part or all of its operations as described herein (e.g., RI data acquisition and adjustment of catalyst or reaction conditions) with partial or no human operator intervention. For example, the control system's operations can be carried out based on predetermined or adaptive control logic and run-time sensor data.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a”, “an”, and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

The present invention has been described in terms of one or more preferred embodiments, and it should be appreciated that many equivalents, alternatives, variations, and modifications, aside from those expressly stated, are possible and within the scope of the invention.

### EXAMPLES

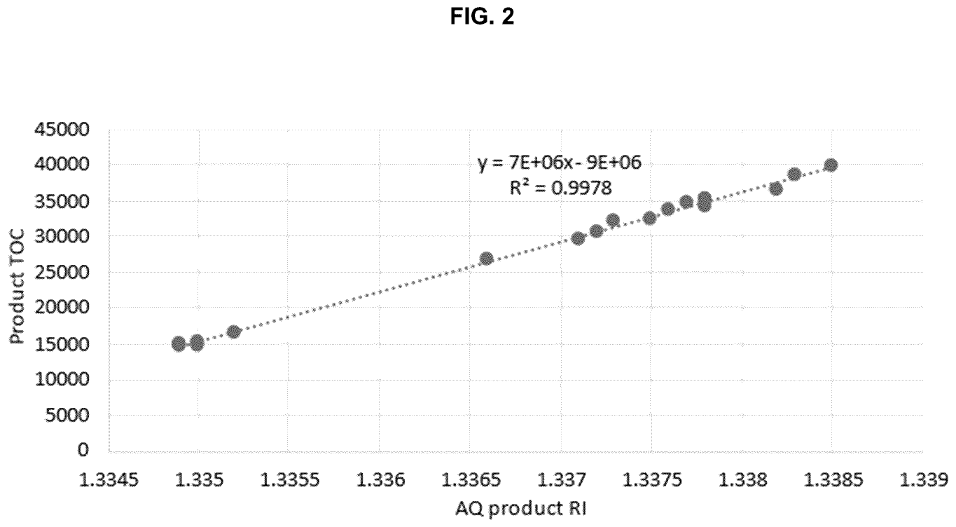

In a pilot study, a linear correlation between the Refractive Index (RI) of wastewater and the total organic carbon (TOC) of the wastewater was established based on an at-line analysis of liquid samples from a 24-hour operation using a handheld RI meter. Similarly, a linear correlation was also observed between RI and product TOC in APR wastewater (FIG. 2).

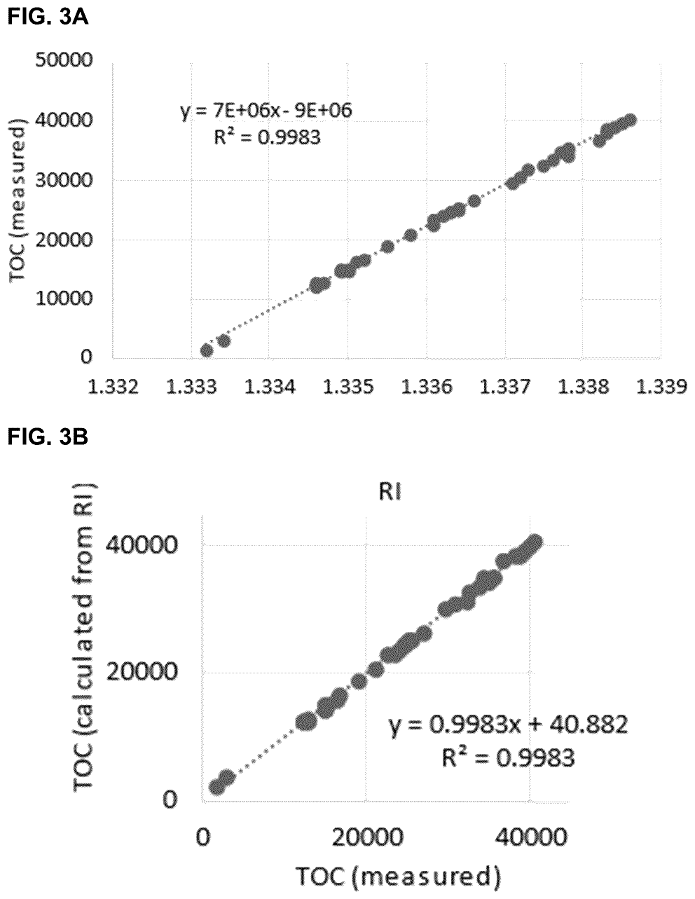

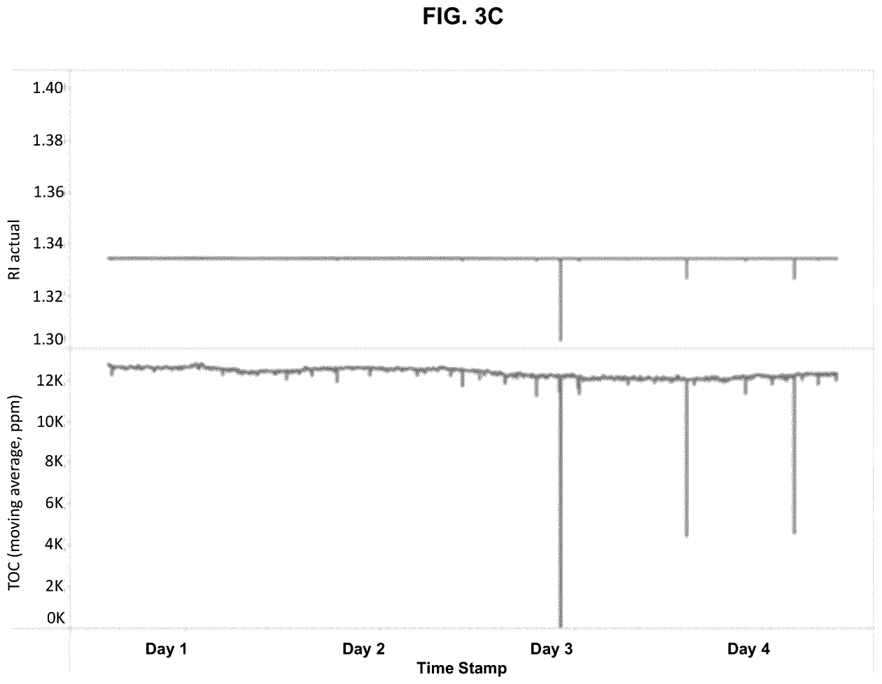

Further studies were conducted in an industrial plant after installation of an in-line refractometer (FIG. 1), and a real-time correlation between RI and the TOC was established (FIGS. 3A-3C). The reactor was operated with a catalyst comprising 5 wt % Pt Pt:Re_{0.5} loaded on 80×120 mesh Calgon 208C. The reactor conditions were 260° C., 625 psig, 36 wt % glycerol, WHSV=1 hr⁻¹. The RI values were converted in real-time to the TOC of the wastewater product, and TOC values of around 12000 ppm were observed. These values correspond to a conversion to gas value of around 95%.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

For reasons of completeness, various aspects of the invention are set out in the following numbered clauses:

Clause 1. A method of controlling a catalytic reaction for hydrogen production, the method comprising:
reacting a feed stream comprising water and a water-soluble oxygenated hydrocarbon having at least two carbon atoms, in the presence of a catalyst and under a reaction condition, to produce a product stream comprising a gaseous phase comprising hydrogen and an aqueous phase comprising wastewater;
determining an outcome of the catalytic reaction by measuring in-line a refractive index of the wastewater; and
adjusting the catalyst, the reaction condition, or both according to the outcome to continue hydrogen production.

Clause 2. The method of clause 1, wherein the outcome comprises a total organic carbon (TOC) of the wastewater, a conversion to gas of the feed stream, hydrogen yield of the catalytic reaction, or a combination thereof.

Clause 3. The method of any one of clauses 1-2, wherein the reaction condition comprises temperature, pressure, concentration of the water-soluble oxygenated hydrocarbon, flow rate of the feed stream, or a combination thereof.

Clause 4. The method of clause 3, wherein the temperature is about 260° C. to about 340° C.

Clause 5. The method of any one of clauses 3-4, wherein the pressure is about 250 psig to about 650 psig.

Clause 6. The method of any one of clauses 3-5, wherein the feed stream comprises about 20% to about 50% by weight a water-soluble oxygenated hydrocarbon.

Clause 7. The method of any one of clauses 3-6, wherein the feed stream has a weight hourly space velocity (WHSV) of about 0.1 hr⁻¹ to about 10 hr⁻¹.

Clause 8. The method of any one of clauses 1-7, wherein the water-soluble oxygenated hydrocarbon comprises glycerol.

Clause 9. The method of any one of clauses 1-7, wherein the catalyst comprises a metal and a support.

Clause 10. The method of clause 9, wherein the metal comprises Pt, Ru, Re, or a combination thereof, and wherein the support comprises activated carbon.

Clause 11. The method of any one of clauses 1-10, wherein adjusting the catalyst comprises regenerating the catalyst.

Clause 12. The method of any one of clauses 1-11, further comprising separating the aqueous phase comprising the wastewater from the product stream prior to measuring in-line the refractive index of the wastewater.

Clause 13. The method of any one of clauses 2-12, wherein determining the outcome of the catalytic reaction comprises determining a linear correlation between the total organic carbon (TOC) and the refractive index of the wastewater.

Clause 14. The method of any one of clauses 1-13, wherein the outcome of the catalytic reaction is determined by an electronic control unit, and/or wherein adjusting the catalyst, the reaction condition, or both is carried out by the control unit.

Clause 15. The method of clause 14, wherein the control unit is an automated control unit.

Clause 16. A system for catalytic reaction to produce hydrogen, comprising:
a reactor configured to: (1) receive a feed stream comprising water and a water-soluble oxygenated hydrocarbon having at least two carbon atoms and a catalyst; and (2) discharge a product stream comprising a gaseous phase comprising hydrogen and an aqueous phase comprising wastewater, wherein the feed stream in the reactor undergoes a reaction in the presence of the catalyst and under a reaction condition to produce the product stream;
an in-line refractive index meter configured to measure a refractive index of the wastewater; and
an electronic control system configured to adjust the catalyst, the reaction condition, or a combination thereof based on the measured refractive index of the wastewater.

Clause 17. The system of clause 16, further comprising a separator unit to separate the aqueous phase comprising the wastewater from the product stream.

Clause 18. The system of any one of clauses 16-17, wherein the water-soluble oxygenated hydrocarbon comprises glycerol.

Clause 19. The system of any one of clauses 16-18, wherein the catalyst comprises a metal and a support.

Clause 20. The system of any one of clauses 16-19, wherein the electronic control system is configured to:
receive refractive index data from the in-line refractive index meter;
determine an outcome of the catalytic reaction based on the refractive index data; and
adjust the catalyst, the reaction condition, or the combination thereof based on the determined outcome.

1. A method of controlling a catalytic reaction for hydrogen production, the method comprising:
reacting a feed stream comprising water and a water-soluble oxygenated hydrocarbon having at least two carbon atoms, in the presence of a catalyst and under a reaction condition, to produce a product stream comprising a gaseous phase comprising hydrogen and an aqueous phase comprising wastewater;
determining an outcome of the catalytic reaction by measuring in-line a refractive index of the wastewater; and
adjusting the catalyst, the reaction condition, or both according to the outcome to continue hydrogen production.

2. The method of claim 1, wherein the outcome comprises a total organic carbon (TOC) of the wastewater, a conversion to gas of the feed stream, hydrogen yield of the catalytic reaction, or a combination thereof.

3. The method of claim 1, wherein the reaction condition comprises temperature, pressure, concentration of the water-soluble oxygenated hydrocarbon, flow rate of the feed stream, or a combination thereof.

4. The method of claim 3, wherein the temperature is about 260° C. to about 340° C.

5. The method of claim 3, wherein the pressure is about 250 psig to about 650 psig.

6. The method of claim 3, wherein the feed stream comprises about 20% to about 50% by weight a water-soluble oxygenated hydrocarbon.

7. The method of claim 3, wherein the feed stream has a weight hourly space velocity (WHSV) of about 0.1 hr⁻¹ to about 10 hr⁻¹.

8. The method of claim 1, wherein the water-soluble oxygenated hydrocarbon comprises glycerol.

9. The method of claim 1, wherein the catalyst comprises a metal and a support.

10. The method of claim 9, wherein the metal comprises Pt, Ru, Re, or a combination thereof, and wherein the support comprises activated carbon.

11. The method of claim 1, wherein adjusting the catalyst comprises regenerating the catalyst.

12. The method of claim 1, further comprising separating the aqueous phase comprising the wastewater from the product stream prior to measuring in-line the refractive index of the wastewater.

13. The method of claim 2, wherein determining the outcome of the catalytic reaction comprises determining a linear correlation between the total organic carbon (TOC) and the refractive index of the wastewater.

14. The method of claim 1, wherein the outcome of the catalytic reaction is determined by an electronic control unit, and/or wherein adjusting the catalyst, the reaction condition, or both is carried out by the control unit.

15. The method of claim 14, wherein the control unit is an automated control unit.

16. A system for catalytic reaction to produce hydrogen, comprising:
a reactor configured to: (1) receive a feed stream comprising water and a water-soluble oxygenated hydrocarbon having at least two carbon atoms and a catalyst; and (2) discharge a product stream comprising a gaseous phase comprising hydrogen and an aqueous phase comprising wastewater, wherein the feed stream in the reactor undergoes a reaction in the presence of the catalyst and under a reaction condition to produce the product stream;
an in-line refractive index meter configured to measure a refractive index of the wastewater; and
an electronic control system configured to adjust the catalyst, the reaction condition, or a combination thereof based on the measured refractive index of the wastewater.

17. The system of claim 16, further comprising a separator unit to separate the aqueous phase comprising the wastewater from the product stream.

18. The system of claim 16, wherein the water-soluble oxygenated hydrocarbon comprises glycerol.

19. The system of claim 16, wherein the catalyst comprises a metal and a support.

20. The system of claim 16, wherein the electronic control system is configured to:
receive refractive index data from the in-line refractive index meter;
determine an outcome of the catalytic reaction based on the refractive index data; and
adjust the catalyst, the reaction condition, or the combination thereof based on the determined outcome.
